(19) United States
(12) Patent Application Publication
(10) Pub. No.: US 2017/0124353 A1
(43) Pub. Date: May 4, 2017

(54) Method And Apparatus For Preventing Rollback Of Secure Data

(71) Applicant: MediaTek Inc., Hsinchu City (TW)

(72) Inventor: Gaurav Arora, Cupertino, CA (US)

(21) Appl. No.: 15/405,252

(22) Filed: Jan. 12, 2017

(51) Int. Cl. G06F 21/64; G06F 21/53

(52) U.S. Cl. CPC G06F 21/64; G06F 21/53; G06F 2221/2151

(57) ABSTRACT

Methods and apparatuses pertaining to anti-rollback of version of secure data may involve comparing a locally stored version number of a set of data and a remotely stored version number of the set of data. A data file may be read in response to a positive result of the comparison. The data file may contain the set of data and a version number of the set of data. The locally stored version number and the version number of the set of data contained in the data file may also be compared, and the set of data may be accessed in response to a positive result of the comparison.

### TECHNICAL FIELD

The present disclosure is generally related to data security and, more particularly, to techniques pertaining to anti-rollback of the version of some secure data via a remote attack.

### BACKGROUND

Unless otherwise indicated herein, approaches described in this section are not prior art to the claims listed below and are not admitted to be prior art by inclusion in this section.

Data security generally refers to the protection of data, such as database(s) and/or data file(s), from destructive forces as well as unwanted actions of unauthorized users. For instance, a remote attack is a malicious action that targets one or more computers to find vulnerable point(s) in the security software of a computer or a network to access the machine or system. A primary reason for remote attacks is to view or obtain secure data unlawfully, introduce virus/viruses or other malicious software, and/or cause damage to the targeted computer or network. Various technologies and approaches have been developed for data security, including software-based and hardware-based mechanisms for protecting data. However, as new techniques for security hacking (e.g., remote attacks) of computer systems and data storage systems are developed, there is a constant need for efficient ways to enhance data security without increasing the complexity and/or cost of the underlying system.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose a novel scheme for anti-rollback of version of secure data. There are many examples where a device needs to ensure that it is accessing the latest version of a piece of secure data (herein interchangeably referred as “secure data blob”). For instance, the device needs to ensure the secure data blob has a version number which is incremented every time the blob is updated. When the device needs to access the blob the device checks that the blob is indeed the latest version and some malicious party has not rolled back the blob to an older version thereof. As an example, features like firmware upgrade and streaming services like Netflix™ would benefit from such kind of functionality. Currently such functionality is supported in devices by using hardware means either via eFUSE inside a system on chip (SoC) or using more expensive flash storage devices such as embedded Multi-Media Card (eMMC) with Replay Protected Memory Block (RPMB) functionality. This present disclosure provides methods and apparatuses that do not require specialized hardware on the device.

In one aspect, a method in accordance with the present disclosure may involve firstly comparing a locally stored version number of a set of data and a remotely stored version number of the set of data. The method may also involve reading a data file responsive to a positive result of the firstly comparing, the data file containing the set of data and a version number of the set of data. The method may further involve secondly comparing the locally stored version number and the version number of the set of data contained in the data file. The method may additionally involve accessing the set of data responsive to a positive result of the secondly comparing.

In another aspect, a method in accordance with the present disclosure may involve reading a data file containing a set of data and a version number of the set of data. The method may involve updating the data file by updating the set of data and incrementing the version number of the set of data. The method may also involve writing the updated data file to a file system. The method may further involve updating a locally stored version number of the set of data. The method may additionally involve updating a remotely stored version number of the set of data.

In another aspect, an apparatus in accordance with the present disclosure may include a memory device and a processor. The memory device may be capable of storing a locally stored version number of a set of data. The processor may be operatively coupled to the memory device, and may include a comparison circuit, a retrieving circuit, an extraction circuit, and an updating circuit. The comparison circuit may be capable of comparing the locally stored version number of the set of data and a remotely stored version number of the set of data to provide a first comparison result. The comparison circuit may be also capable of comparing the locally stored version number of the set of data and a version number of the set of data contained in a data file to provide a second comparison result. The retrieving circuit may be capable of reading the data file containing the set of data and the version number of the set of data based on the first comparison result. The extraction circuit may be capable of accessing the set of data to extract information from the set of data based on the second comparison result. The updating circuit may be capable of updating the data file, the locally stored version number and the remotely stored version number.

### BRIEF DESCRIPTION OF THE DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example operation in accordance with an implementation of the present disclosure.

FIG. 2 is a diagram of an example operation in accordance with another implementation of the present disclosure.

FIG. 3 is a block diagram of an example apparatus in accordance with an implementation of the present disclosure.

FIG. 4 is a flowchart of an example process in accordance with an implementation of the present disclosure.

FIG. 5 is a flowchart of an example process in accordance with another implementation of the present disclosure.

FIG. 6 is a diagram of an example scenario in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

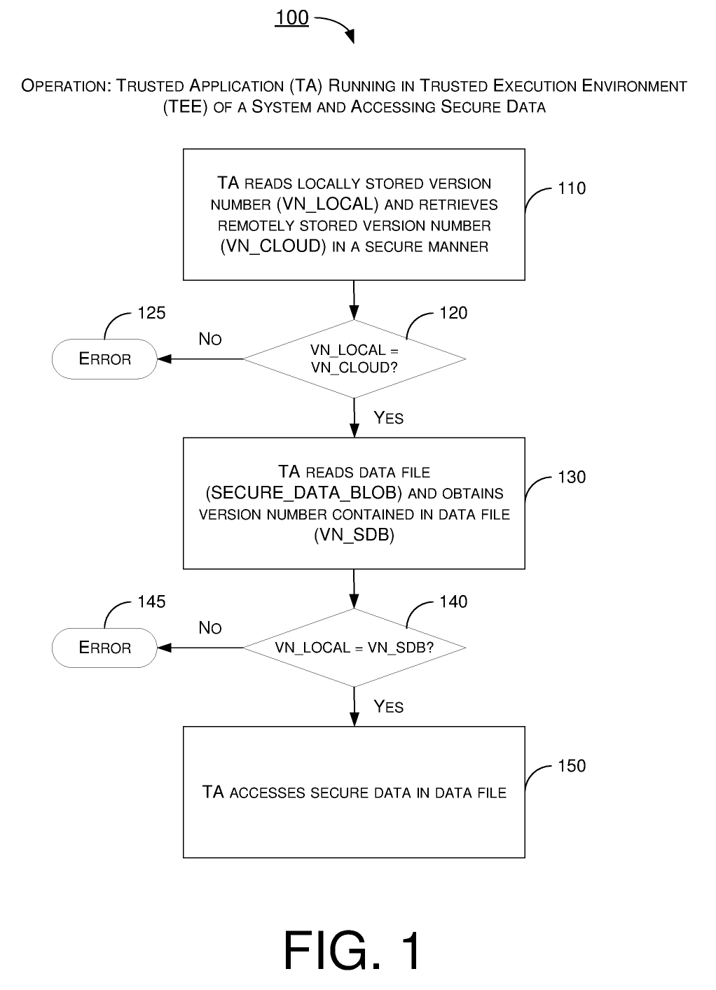

FIG. 1 illustrates an example operation 100 in accordance with an implementation of the present disclosure. Operation 100 may pertain to a scenario in which a trusted application (TA) running in a trusted execution environment (TEE) needs to access secure data. The TA may be executed by or otherwise implemented in a processor. Operation 100 may include one or more actions or functions as illustrated by one or more of blocks 110, 120, 125, 130, 140, 145 and 150.

At 110, TA may read a locally stored version number (VN_LOCAL) of a set of data (e.g., the secure data to be accessed) and retrieve a remotely stored version number (VN_CLOUD) of the set of data in a secure manner. Either or both of VN_LOCAL and VN_CLOUD may be encrypted and signed to ensure secrecy and integrity. The communication between the TA and a cloud storage in which VN_CLOUD is stored may be achieved through one or more secure sockets implemented on the TEE side. Additionally, one or more timestamps associated with VN_CLOUD may be validated as an additional layer of security to ensure no replay attack. Operation 100 may proceed from 110 to 120.

At 120, VN_LOCAL and VN_CLOUD may be compared to determine whether they are identical (or differ by no more than 1). The comparison may be relaxed to allow VN LOCAL and VN CLOUD to differ within +/−1 to account for any random crash while updating VN_CLOUD. In some implementations, a value different than 1 may be used. In an event that VN_LOCAL and VN_CLOUD are not identical or differ by more than 1, then operation 100 may proceed from 120 to 125 to end in error (and an error message may be generated). In an event that VN_LOCAL and VN_CLOUD are identical or differ by no more than 1, then operation 100 may proceed from 120 to 130.

At 130, TA may read a data file (SECURE DATA BLOB) and obtain, from the data file, a version number (VN_SDB) of the set of data which is contained in the SECURE_DATA BLOB. Operation 100 may proceed from 130 to 140.

At 140, VN_LOCAL and VN_SDB may be compared to determine whether or not they are identical. In an event that VN_LOCAL and VN_CLOUD are not identical, then operation 100 may proceed from 140 to 145 to end in error (and an error message may be generated). In an event that VN_LOCAL and VN_CLOUD are identical, then operation 100 may proceed from 140 to 150.

At 150, TA may access the set of data contained in the data file.

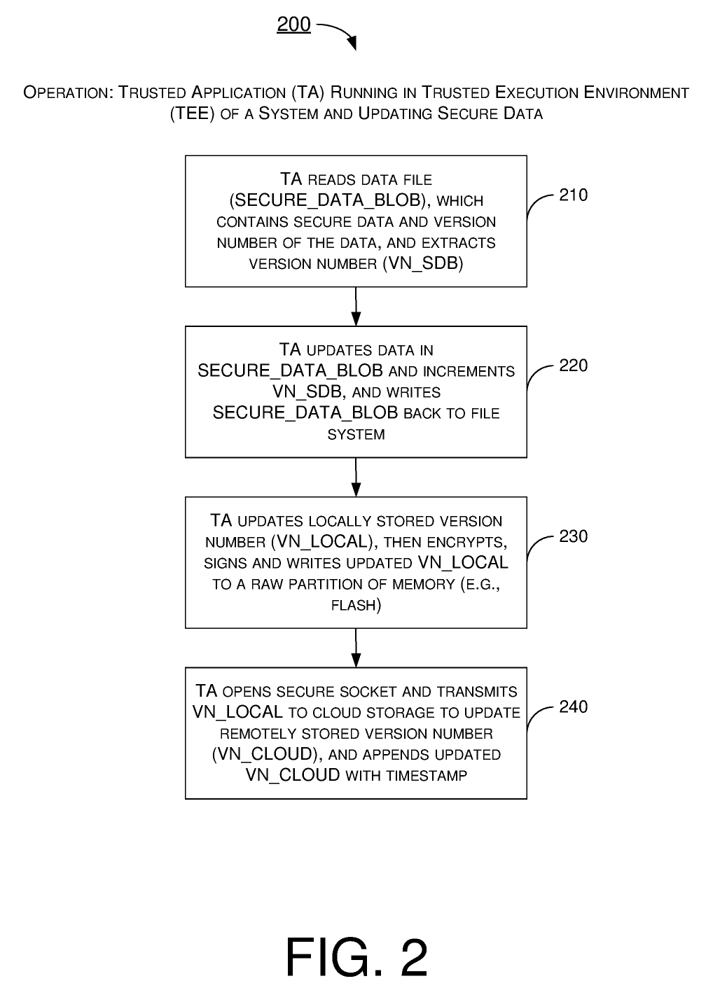

FIG. 2 illustrates an example operation 200 in accordance with another implementation of the present disclosure. Operation 200 may pertain to a scenario in which a TA running in a TEE needs to update secure data. The TA may be executed by or otherwise implemented in a processor. Operation 200 may include one or more actions or functions as illustrated by one or more of blocks 210, 220, 230 and 240.

At 210, TA may read from a file system a data file (SECURE_DATA_BLOB), which contains a set of data (e.g., secure data) and a version number (VN_SDB) of the set of data. TA may also extract the version number. Operation 200 may proceed from 210 to 220.

At 220, TA may update the data in SECURE DATA_BLOB and increment VN_SDB. TA may also write SECURE_DATA_BLOB back to the file system. Operation 200 may proceed from 220 to 230.

At 230, TA may update a locally stored version number (VN_LOCAL) of the set of data. TA may encrypt, sign and write the updated VN_LOCAL to a raw partition of a memory device (e.g., flash memory). Operation 200 may proceed from 230 to 240.

At 240, TA may open one or more secure sockets to transmit the updated VN_LOCAL to a cloud storage to update a remotely stored version number (VN_CLOUD) of the set of data by replacing the existing VN_CLOUD with the updated VN_LOCAL as the new or updated VN_CLOUD. TA may also append the updated VN_CLOUD with a timestamp. Illustrative Implementations

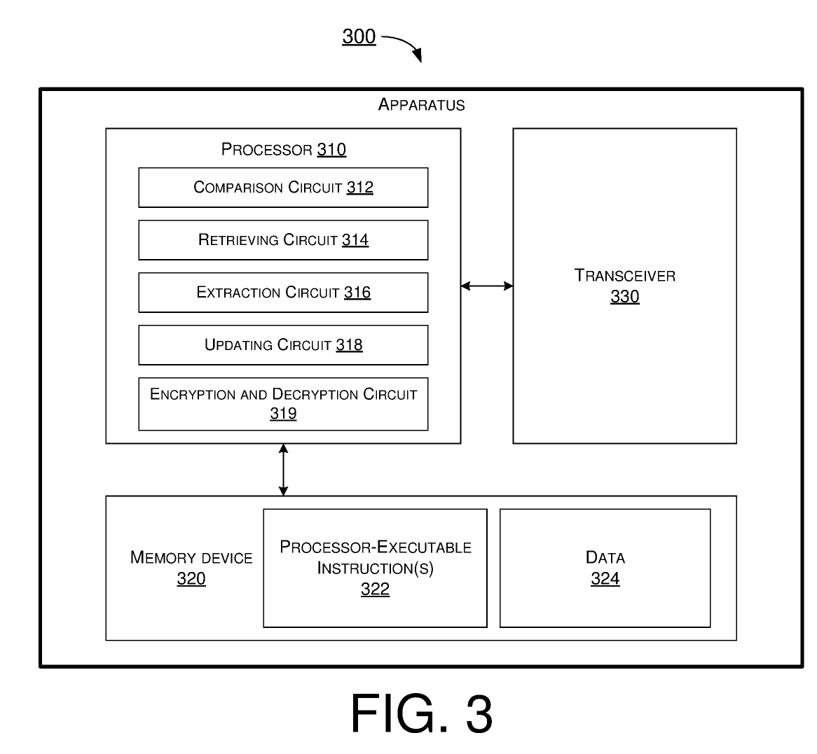

FIG. 3 illustrates an example apparatus 300 in accordance with an implementation of the present disclosure. Apparatus 300 may perform various functions to implement schemes, techniques, processes and methods described herein pertaining to anti-rollback of version of secure data, including operation 100 and operation 200 described above as well as process 400 and process 500 described below. Apparatus 300 may be a part of an electronic apparatus, which may be a portable or mobile apparatus, a wearable apparatus, a wireless communication apparatus or a computing apparatus. For instance, apparatus 300 may be implemented in a smartphone, a smartwatch, a smart bracelet, a smart necklace, a personal digital assistant, or a computing equipment such as a tablet computer, a laptop computer, a notebook computer, a desktop computer, or a server. Alternatively, apparatus 300 may be implemented in the form of one or more integrated-circuit (IC) chips such as, for example and not limited to, one or more single-core processors, one or more multi-core processors, or one or more complex-instruction-set-computing (CISC) processors. Apparatus 300 may include one, some or all of those components shown in FIG. 3, such as a processor 310 and a memory device 320. Additionally, apparatus 300 may include a transceiver 330. Apparatus 300 may further include other components not pertinent to the proposed scheme of the present disclosure (e.g., internal power supply, display device and/or user interface device), which are neither shown in FIG. 3 nor described below in the interest of simplicity and brevity.

Memory device 320 may be configured, designed or otherwise adapted to store one or more sets of instructions, codes and/or software programs 322 as well as data 324. Data 324 may include, for example and without limitation, a locally stored version number of a set of data (e.g., secure data) contained in a data file. Memory device 320 may be implemented by any suitable technology and may include volatile memory and/or non-volatile memory. For example, memory device 320 may include a type of random access memory (RAM) such as dynamic RAM (DRAM), static RAM (SRAM), thyristor RAM (T-RAM) and/or zero-capacitor RAM (Z-RAM). Alternatively or additionally, memory device 320 may include a type of read-only memory (ROM) such as mask ROM, programmable ROM (PROM), erasable programmable ROM (EPROM) and/or electrically erasable programmable ROM (EEPROM). Alternatively or additionally, memory device 320 may include a type of non-volatile random-access memory (NVRAM) such as flash memory, solid-state memory, ferroelectric RAM (FeRAM), magnetoresistive RAM (MRAM) and/or phase-change memory.

Transceiver 330 may be configured, designed or otherwise adapted to transmit and receive data in the form of electromagnetic waves, or signals, wirelessly and/or via one or more wires. For instance, transceiver 330 may be capable of wireless communication in accordance with any wireless technology, standard and/or specification application to the present disclosure such as, for example and without limitation, Institute of Electrical and Electronic Engineers (IEEE) 802.11 specifications and wireless mobile telecommunications technologies such as Long-Term Evolution (LTE) and its derivatives and variations. Thus, processor 310 may transmit and receive data (e.g., access and retrieve remote data and information) through transceiver 330.

In one aspect, processor 310 may be implemented in the form of one or more single-core processors, one or more multi-core processors, or one or more CISC processors. That is, even though a singular term “a processor” may be used herein to refer to processor 310, processor 310 may include multiple processors in some implementations and a single processor in other implementations in accordance with the present disclosure. In another aspect, processor 310 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, processor 310 is a special-purpose machine specifically designed, arranged and configured to perform specific tasks including anti-rollback of version of secure data in accordance with various implementations of the present disclosure.

Processor 310, as a special-purpose machine, may include non-generic and specially-designed hardware circuits that are designed, arranged and configured to perform specific tasks pertaining to anti-rollback of version of secure data in accordance with various implementations of the present disclosure. For instance, processor 310 may include some or all of a comparison circuit 312, a retrieving circuit 314, an extraction circuit 316, an updating circuit 318, and an encryption and decryption circuit 319 that, together, perform specific tasks and functions to render anti-rollback of version of secure data in accordance with various implementations of the present disclosure. For instance, comparison circuit 312 may compare the locally stored version number of the set of data and a remotely stored version number of the set of data to provide a first comparison result. Moreover, comparison circuit 312 may compare the locally stored version number of the set of data and a version number of the set of data contained in the data file to provide a second comparison result. Retrieving circuit 314 may, based on the first comparison result, read the data file (e.g., from a file system that is local or remote with respect to apparatus 300), which contains the set of data and the version number of the set of data. Extraction circuit 316 may, based on the second comparison result, access the set of data to extract information from the set of data. Updating circuit 318 may update each, some or all of the data file, the locally stored version number and the remotely stored version number.

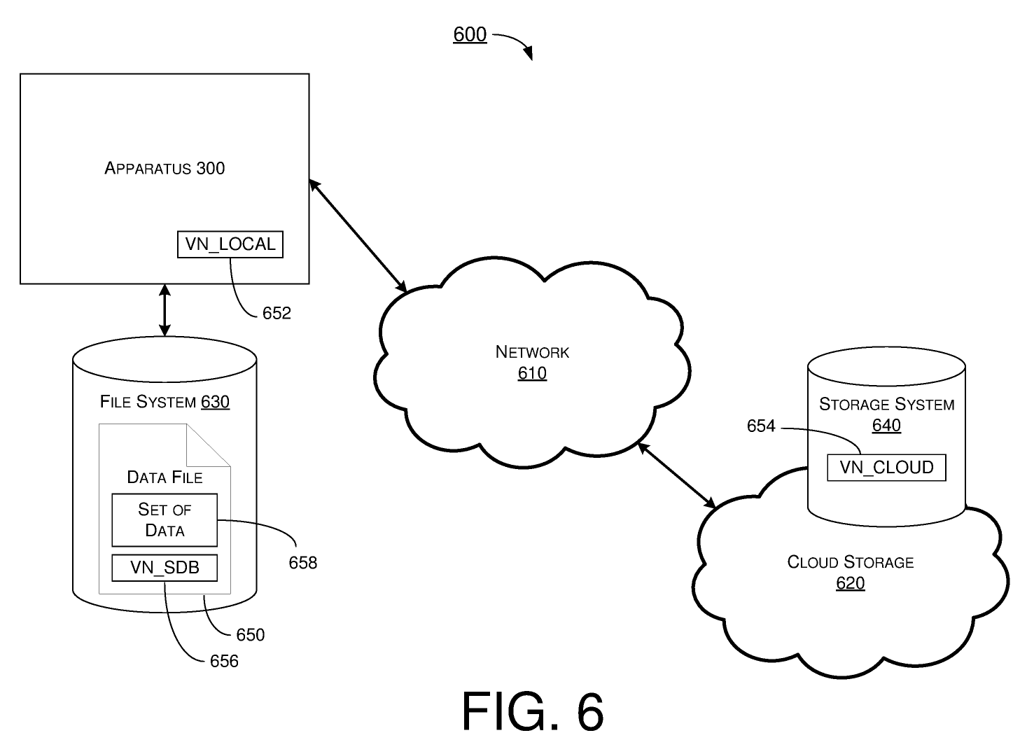

Referring to FIG. 6, which illustrates an example scenario 600 in which apparatus 300 may be implemented in accordance with the present disclosure, apparatus 300 may have a locally stored version number (VN_LOCAL) stored therein (e.g., in memory device 320). Apparatus 300 may be communicatively coupled to a file system 630, which stores a data file 650 therein. Data file 650 may contain a set of data 658 (e.g., secure data) as well as a version number 656 of the set of data (VN_SDB). Apparatus 300 may also be communicative coupled to a cloud storage 620, including one or more storage systems such as a storage system 640, via a network 610. Network 610 may include one or more local area networks (LAN), one or more wide area networks (WAN), one or more metropolitan area networks (MAN), one or more wired networks, one or more wireless networks and/or the Internet. Storage system 640 may store a remotely stored version number 654 of the set of data (VN_CLOUD). Apparatus 300 (e.g., processor 310) may perform operations pertaining to anti-rollback of version of the set of data 658 as described herein with respect to apparatus 300, as well as those described with respect to operation 100, operation 200, process 400 and process 500.

In some implementations, retrieving circuit 314 may be capable of performing an operation that involves retrieving the locally stored version number from memory device 320. The operation may also involve retrieving the remotely stored version number from a cloud storage through a secure socket implemented by a trusted execution environment (TEE). Moreover, retrieving circuit 314 may also validate one or more timestamps associated with the remotely stored version number.

In some implementations, encryption and decryption circuit 319 may be capable of performing an operation that involves encrypting at least one of the locally stored version number and the remotely stored version number. The operation may also involve decrypting the at least one of the locally stored version number and the remotely stored version number prior to the comparison circuit comparing the locally stored version number and the remotely stored version number. The operation may further involve decrypting the remotely stored version number prior to the comparison circuit comparing the locally stored version number and the version number of the set of data contained in the data file.

In some implementations, retrieving circuit 314 may read the data file in response to the first comparison result indicating that the locally stored version number and the remotely stored version number are identical. Alternatively or additionally, retrieving circuit 314 may read the data file in response to the first comparison result indicating that the locally stored version number and the remotely stored version number differ by no more than 1.

In some implementations, updating circuit 318 may update the data file by performing an operation that involves updating the data file by updating the set of data and incrementing the version number of the set of data. The operation may also involve writing the updated data file to a file system.

In some implementations, updating circuit 318 may update the locally stored version number by performing an operation that involves incrementing the locally stored version number. The operation may also involve encrypting the locally stored version number. The operation may further involve signing the locally stored version of the set of data. The operation may further involve writing the updated locally stored version number to a raw partition of a local storage device.

In some implementations, updating circuit 318 may update the remotely stored version number by performing an operation that involves updating the locally stored version number. This may include incrementing the locally stored version number, encrypting the locally stored version number, and signing the locally stored version of the set of data. The operation may also involve opening a secure socket implemented by a TEE. The operation may additionally involve transmitting the updated locally stored version number to a cloud storage via the secure socket. The operation may further involve replacing the remotely stored version number, which is stored at the cloud storage, with the updated locally stored version number. The operation may also involve appending a timestamp to the remotely stored version number to indicate a time at which the remotely stored version number is updated.

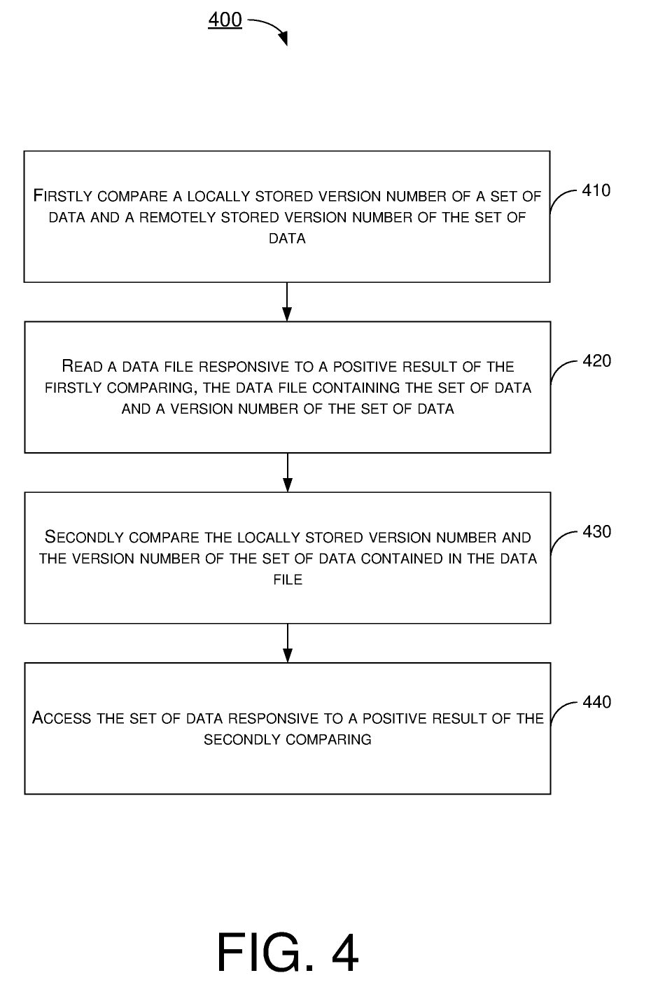

FIG. 4 illustrates an example process 400 in accordance with an implementation of the present disclosure. Process 400 may be an example implementation of operation 100, whether partially or completely, with respect to anti-rollback of version of secure data. Process 400 may represent an aspect of implementation of features of apparatus 300. Process 400 may include one or more operations, actions, or functions as illustrated by one or more of blocks 410, 420, 430 and 440. Although illustrated as discrete blocks, various blocks of process 400 may be divided into additional blocks, combined into fewer blocks, or eliminated, depending on the desired implementation. Moreover, the blocks of process 400 may executed in the order shown in FIG. 4 or, alternatively, in a different order. Process 400 may be implemented by apparatus 300. Solely for illustrative purposes and without limitation, process 400 is described below in the context of apparatus 300 in scenario 600. Process 400 may begin at either block 410.

At 410, process 400 may involve processor 310 of apparatus 300 firstly comparing a locally stored version number of a set of data (e.g., VN_LOCAL 652) and a remotely stored version number of the set of data (e.g., VN_CLOUD 654). Process 400 may proceed from 410 to 420.

At 420, process 400 may involve processor 310 of apparatus 300 reading a data file (e.g., data file 650) responsive to a positive result of the firstly comparing. The data file may contain the set of data (e.g., set of data 658) and a version number of the set of data (e.g., VN_SDB 656). Process 400 may proceed from 420 to 430.

At 430, process 400 may involve processor 310 of apparatus 300 secondly comparing the locally stored version number and the version number of the set of data contained in the data file. Process 400 may proceed from 430 to 440.

At 440, process 400 may involve processor 310 of apparatus 300 accessing the set of data responsive to a positive result of the secondly comparing. For instance, process 400 may involve processor 310 extracting VN_SDB, name, age and address of a user or customer from the set of data 658.

In some implementations, in firstly comparing the locally stored version number and the remotely stored version number, process 400 may involve processor 310 retrieving the locally stored version number from a local storage device (e.g., memory device 320). Moreover, process 400 may involve processor 310 retrieving the remotely stored version number from a cloud storage (e.g., storage system 640 of cloud storage 620) through a secure socket implemented by a TEE (e.g., a TEE implemented in processor 310). Furthermore, process 400 may involve processor 310 validating one or more timestamps associated with the remotely stored version number.

In some implementations, at least one of the locally stored version number and the remotely stored version number may be encrypted. In such cases, in firstly comparing the locally stored version number and the remotely stored version number, process 400 may involve processor 310 decrypting the at least one of the locally stored version number and the remotely stored version number that is encrypted prior to the firstly comparing. Alternatively or additionally, process 400 may involve processor 310 decrypting the remotely stored version number prior to the secondly comparing.

In some implementations, the positive result of the firstly comparing may include a determination that the locally stored version number and the remotely stored version number are identical. Alternatively, the positive result of the firstly comparing may include a determination that the locally stored version number and the remotely stored version number differ by no more than 1.

In some implementations, in accessing the set of data, process 400 may involve processor 310 accessing the set of data by a trusted application running in a TEE.

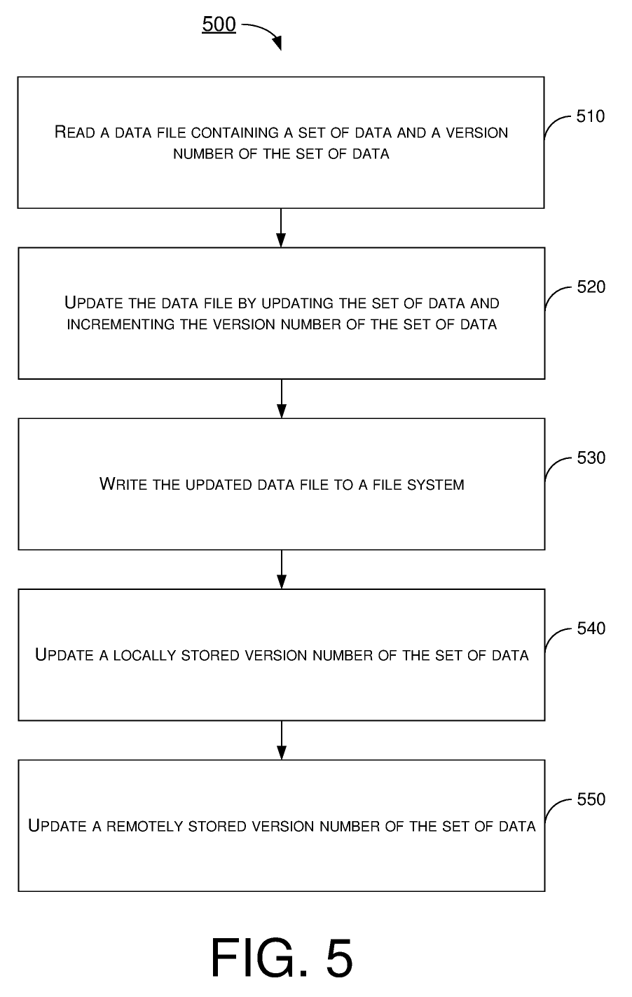

FIG. 5 illustrates an example process 500 in accordance with an implementation of the present disclosure. Process 500 may be an example implementation of operation 200, whether partially or completely, with respect to anti-rollback of version of secure data. Process 500 may represent an aspect of implementation of features of apparatus 500. Process 500 may include one or more operations, actions, or functions as illustrated by one or more of blocks 510, 520, 530, 540 and 550. Although illustrated as discrete blocks, various blocks of process 500 may be divided into additional blocks, combined into fewer blocks, or eliminated, depending on the desired implementation. Moreover, the blocks of process 500 may executed in the order shown in FIG. 5 or, alternatively, in a different order. Process 500 may be implemented by apparatus 300. Solely for illustrative purposes and without limitation, process 500 is described below in the context of apparatus 300 in scenario 600. Process 500 may begin at either block 510.

At 510, process 500 may involve processor 310 of apparatus 300 reading a data file (e.g., data file 650) containing a set of data (e.g., set of data 658) and a version number of the set of data (e.g., VN_SDB 656). Process 500 may proceed from 510 to 520.

At 520, process 500 may involve processor 310 of apparatus 300 updating the data file by updating the set of data and incrementing the version number of the set of data. Process 500 may proceed from 520 to 530.

At 530, process 500 may involve processor 310 of apparatus 300 writing the updated data file to a file system (e.g., file system 630). Process 500 may proceed from 530 to 540.

At 540, process 500 may involve processor 310 of apparatus 300 updating a locally stored version number of the set of data (e.g., VN_LOCAL 652). Process 500 may proceed from 540 to 550.

At 550, process 500 may involve processor 310 of apparatus 300 updating a remotely stored version number of the set of data (e.g., VN_CLOUD 654).

In some implementations, in updating the locally stored version number, process 500 may involve processor 310 incrementing the locally stored version number. Additionally, process 500 may involve processor 310 encrypting the locally stored version number. Moreover, process 500 may involve processor 310 signing the locally stored version of the set of data. Furthermore, process 500 may involve processor 310 writing the updated locally stored version number to a raw partition of a local storage device (e.g. memory device 320).

In some implementations, in updating the remotely stored version number, process 500 may involve processor 310 updating the locally stored version number by performing an operation that includes incrementing the locally stored version number, encrypting the locally stored version number, and signing the locally stored version of the set of data. Additionally, process 500 may involve processor 310 opening a secure socket implemented by a TEE (e.g., a TEE implemented in processor 310). Moreover, process 500 may involve processor 310 transmitting the updated locally stored version number to a cloud storage (e.g., storage system 640 of cloud storage 620) via the secure socket. Furthermore, process 500 may involve processor 310 replacing the remotely stored version number, which is stored at the cloud storage, with the updated locally stored version number. In some implementations, in updating the remotely stored version number, process 500 may also involve processor 310 appending a timestamp to the remotely stored version number to indicate a time at which the remotely stored version number is updated.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “ a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
firstly comparing a locally stored version number of a set of data and a remotely stored version number of the set of data;
reading a data file responsive to a positive result of the firstly comparing, the data file containing the set of data and a version number of the set of data;
secondly comparing the locally stored version number and the version number of the set of data contained in the data file; and
accessing the set of data responsive to a positive result of the secondly comparing.

2. The method of claim 1, wherein the firstly comparing of the locally stored version number and the remotely stored version number comprises:
retrieving the locally stored version number from a local storage device; and
retrieving the remotely stored version number from a cloud storage through a secure socket implemented by a trusted execution environment (TEE).

3. The method of claim 2, further comprising:
validating one or more timestamps associated with the remotely stored version number.

4. The method of claim 1, wherein at least one of the locally stored version number and the remotely stored version number is encrypted, and wherein the firstly comparing of the locally stored version number and the remotely stored version number further comprises one or more of:
decrypting the at least one of the locally stored version number and the remotely stored version number that is encrypted prior to the firstly comparing; and
decrypting the remotely stored version number prior to the secondly comparing.

5. The method of claim 1, wherein the positive result of the firstly comparing comprises a determination that the locally stored version number and the remotely stored version number are identical or a determination that the locally stored version number and the remotely stored version number differ by no more than 1.

6. The method of claim 1, wherein the accessing of the set of data comprises accessing the set of data by a trusted application running in a trusted execution environment (TEE).

7. A method, comprising:
reading a data file containing a set of data and a version number of the set of data;
updating the data file by updating the set of data and incrementing the version number of the set of data;
writing the updated data file to a file system;
updating a locally stored version number of the set of data; and
updating a remotely stored version number of the set of data.

8. The method of claim 7, wherein the updating of the locally stored version number comprises:
incrementing the locally stored version number;
encrypting the locally stored version number; and
signing the locally stored version of the set of data.

9. The method of claim 8, wherein the updating of the locally stored version number further comprises:
writing the updated locally stored version number to a raw partition of a local storage device.

10. The method of claim 7, wherein the updating of the remotely stored version number comprises:
updating the locally stored version number by performing an operation comprising:
incrementing the locally stored version number;
encrypting the locally stored version number; and
signing the locally stored version of the set of data.

11. The method of claim 10, wherein the updating of the remotely stored version number further comprises:
opening a secure socket implemented by a trusted execution environment (TEE);
transmitting the updated locally stored version number to a cloud storage via the secure socket; and
replacing the remotely stored version number, which is stored at the cloud storage, with the updated locally stored version number.

12. The method of claim 11, wherein the updating of the remotely stored version number further comprises:
appending a timestamp to the remotely stored version number to indicate a time at which the remotely stored version number is updated.

13. An apparatus, comprising:
a memory device capable of storing a locally stored version number of a set of data; and
a processor operatively coupled to the memory device, the processor comprising:
a comparison circuit capable of comparing the locally stored version number of the set of data and a remotely stored version number of the set of data to provide a first comparison result, the comparison circuit also capable of comparing the locally stored version number of the set of data and a version number of the set of data contained in a data file to provide a second comparison result;
a retrieving circuit capable of reading the data file containing the set of data and the version number of the set of data based on the first comparison result;
an extraction circuit capable of accessing the set of data to extract information from the set of data based on the second comparison result; and
an updating circuit capable of updating the data file, the locally stored version number and the remotely stored version number.

14. The apparatus of claim 13, wherein the retrieving circuit is also capable of performing an operation comprising:
retrieving the locally stored version number from the memory device; and
retrieving the remotely stored version number from a cloud storage through a secure socket implemented by a trusted execution environment (TEE).

15. The apparatus of claim 13, wherein the retrieving circuit is further capable of performing an operation comprising:
validating one or more timestamps associated with the remotely stored version number.

16. The apparatus of claim 13, further comprising:
an encryption and decryption circuit capable of performing an operation comprising:
encrypting at least one of the locally stored version number and the remotely stored version number;
decrypting the at least one of the locally stored version number and the remotely stored version number prior to the comparison circuit comparing the locally stored version number and the remotely stored version number; and
decrypting the remotely stored version number prior to the comparison circuit comparing the locally stored version number and the version number of the set of data contained in the data file.

17. The apparatus of claim 13, wherein the retrieving circuit reads the data file responsive to the first comparison result indicating that the locally stored version number and the remotely stored version number are identical or that the locally stored version number and the remotely stored version number differ by no more than 1.

18. The apparatus of claim 13, wherein the updating circuit updates the data file by performing an operation comprising:
updating the data file by updating the set of data and incrementing the version number of the set of data; and
writing the updated data file to a file system.

19. The apparatus of claim 13, wherein the updating circuit updates the locally stored version number by performing an operation comprising:
incrementing the locally stored version number;
encrypting the locally stored version number;
signing the locally stored version of the set of data; and
writing the updated locally stored version number to a raw partition of a local storage device.

20. The apparatus of claim 13, wherein the updating circuit updates the remotely stored version number by performing an operation comprising:
updating the locally stored version number by performing an operation comprising:
incrementing the locally stored version number;
encrypting the locally stored version number; and
signing the locally stored version of the set of data;
opening a secure socket implemented by a trusted execution environment (TEE);
transmitting the updated locally stored version number to a cloud storage via the secure socket;
replacing the remotely stored version number, which is stored at the cloud storage, with the updated locally stored version number; and
appending a timestamp to the remotely stored version number to indicate a time at which the remotely stored version number is updated.
